(19) United States
(12) Patent Application Publication
(10) Pub. No.: US 2020/0029545 A1
(43) Pub. Date: Jan. 30, 2020

(54) BEDDING MATERIAL HAVING A BED BUG MONITOR SYSTEM

(71) Applicant: Eric Jeffery Snell, Meansville, GA (US)

(72) Inventor: Eric Jeffery Snell, Meansville, GA (US)

(21) Appl. No.: 16/522,207

(22) Filed: Jul. 25, 2019

Related U.S. Application Data
(60) Provisional application No. 62/703,651, filed on Jul. 26, 2018.

(51) Int. Cl. A01M 1/02

(52) U.S. Cl. CPC A01M 1/026; A01M 1/103; A01M 1/023

(57) ABSTRACT

Bedding material having a bed bug monitor. The bedding material includes at least one bed bug monitoring interface adapted to receive a bed bug monitor, whereby the monitor gathers bed bugs and/or evidence thereof and is subject to visual inspection.

### CROSS-REFERENCE TO RELATED APPLICATION

This application claims priority under 35 U.S.C. § 119(e) to U.S. Provisional Application Ser. No. 62/703,651, filed Jul. 26, 2018, and entitled “Bedding Materials Having Bed Bug Monitor,” the disclosure of which is hereby incorporated by reference in its entirety for all purposes.

### BACKGROUND OF THE DISCLOSURE

The present disclosure relates in general to pest monitoring and in particular to methods and apparatus for monitoring bed bugs and related pests.

Bed bug infestations are increasing at an alarming rate throughout the world. However, existing chemical control methods such as fumigation and the like are not keeping pace due to the growing resistance of bed bugs to insecticides. Similarly, thermal or heat treatment is commonly used as a means to combat bed bugs, but such treatment also has its disadvantages. For instance, apart from the obvious danger of using high energy heaters in enclosed spaces, it has been observed that some bed bugs successfully flee the heat-treated area only to return later. Consequently, because of the limitations of current pesticidal and thermal treatment methods, it is difficult to completely kill or remove all bed bugs that infest a room.

The bed frame, mattress, box spring, and headboard are some of the most heavily infested areas of a typical bedroom. There are presently no reliable methods or apparatus for monitoring the extent of a bed bug infestation near these areas.

Mattress protectors and encasements, box spring skirts, fitted and unfitted bed sheets and other bedding material tend to entrap bed bugs which are behaviorally inclined to climb upward and do not readily return downward when they are blocked from moving further upward by the bedding material. With humans sleeping on the bed above the bedding materials, the bed bugs are even more inclined to spend considerable time searching for an escape route in the upper section of the bedding material and not downward for the obvious escape route. As such, the bed bugs tend to gather under the top component of the bedding material. When gathered as such, their mouth parts may penetrate the bedding material and they may bite humans sleeping or resting on the upper surface of the bedding material.

A need exists, therefore, for a device and method for accurately and reliably monitoring the extent to which bed bugs have infested a mattress, box spring, or other bedding structure. Equipped with such knowledge, effective treatments may be implemented to treat the infestation.

### SUMMARY OF THE INVENTION

In accordance with a first aspect of the subject disclosure, there is provided a bed bug monitoring system comprising bedding material equipped with a bed bug monitoring interface for receiving a bed bug monitor. As used herein, the term “bedding material” shall mean a part of a mattress or box spring, a pesticide treated fabric, or any bed and/or box spring covering, encasement, protector, or fitted or unfitted sheet, whether open- or closed-bottomed. Additionally, as used herein, the term “bed bug monitor” shall include, without limitation, e.g., a glue trap, a pitfall trap, harborage such as fibrous materials that are conducive to bed bug harborage, e.g., corrugated cardboard, and textured materials that retain pesticides in a fashion that allows bed bugs to pick up the pesticides on their bodies when exposed thereto, any or all of which may include at least one lure sufficient to attract bed bugs, such as, for example, pheromones, blood, heat, vapor, and gas (e.g., CO₂). The bed bug monitor provides an indication of a bed bug infestation, which can include live and/or dead bugs of any size/stage, fecal stains, or cast skins left behind when they molt between each stage.

In certain embodiments of the subject disclosure, the bedding material includes a top component for covering the top surface of a mattress or box spring and a side component downwardly depending from the top component about a perimeter of the top component so as to surround one or more sidewalls of the mattress or box spring. One or more bed bug monitors may be placed in bed bug monitoring interfaces adjacent the top component and/or side component at an inner surface thereof. In certain embodiments, the bed bug monitor(s) are placed at or adjacent to one or more corners of the bedding material, as all straight horizontal and vertical bed lines and surfaces, which are preferred pathways for bed bug movement, end up at the corners of the bed.

The bed bug monitors are removably attachable to the bedding material. The bed bug monitors may be constructed as panels formed of fibrous harborage materials or textured materials for retaining pesticides. Alternatively, the bed bug monitors may be a glue trap or a pitfall trap. The bed bug monitors may be received in a pocket or pouch, an elastic strap harness, or other type of bed bug monitoring interface having openings for permitting access of bed bugs to the bed bug monitor. The bed bug monitoring interface may be selectively closable by a fastener such as, e.g., a slot, a flap, a Velcro® hook and loop-type fastener, a snap, a button, or a zipper. In certain embodiments, the bed bug monitoring interface is disposed adjacent an inner surface of the top component or an inner surface of the side component of the bedding material.

In accordance with another aspect of the subject disclosure, there is provided a bed system comprising a mattress or box spring, and a bed bug monitoring interface adjacent the mattress or box spring. The bed system further includes a bed bug monitor received in the bed bug monitoring interface. The bed bug monitoring interface and the bed bug monitor may be constructed and arranged as described above.

Other features and advantages of the subject disclosure will be apparent from the following detailed description, taken in conjunction with the accompanying drawings, which illustrate, by way of example, the principles of the subject disclosure.

### BRIEF DESCRIPTION OF THE SEVERAL VIEWS OF THE DRAWINGS

The foregoing embodiments, as well as the following detailed description of the present disclosure, will be better understood when considered in view of the appended drawings. For the purposes of illustrating the disclosure, there are shown in the drawings exemplary embodiments. It should be understood, however, that the disclosure is not limited to the precise arrangements and instrumentalities shown.

In the drawings:

FIG. 1 is a side partial cross-sectional view of a bed covered with bedding materials incorporating a plurality of bed bug monitors in accordance with an exemplary embodiment of the subject disclosure;

FIG. 2 is a front perspective view of a bed bug monitor in accordance with an embodiment of the subject disclosure;

FIG. 3 is an internal view of a side component of a bedding material including a mesh pouch for removably retaining the bed bug monitor of FIG. 2; and

FIG. 4 is an internal view of a top component of a bedding material including an elastic band harness for removably retaining the bed bug monitor of FIG. 2.

### DETAILED DESCRIPTION OF THE DISCLOSURE

Reference will now be made in detail to the various aspects of the present disclosure illustrated in the accompanying drawings. Wherever possible, the same or like reference numbers will be used throughout the drawings to refer to the same or like features. It should be noted that the drawings are in simplified form and are not drawn to precise scale. In reference to the disclosure herein, for purposes of convenience and clarity only, directional terms such as top, bottom, left, right, above, below and diagonal, are used with respect to the accompanying drawings. Such directional terms used in conjunction with the following description of the drawings should not be construed to limit the scope of the present disclosure in any manner not explicitly set forth. Additionally, the term “a,” as used in the specification, means “at least one.” The terminology includes the words above specifically mentioned, derivatives thereof, and words of similar import.

The term “about,” as used herein when referring to a measurable value, such as an amount, a temporal duration, and the like, is meant to encompass variations of ±20%, ±10%, ±5%, ±1%, or ±0.1% from the specified value, as such variations are appropriate.

The term “substantially,” as used herein, shall mean considerable in extent, largely, but not wholly, that which is specified, or an appropriate variation therefrom as is acceptable within the field of art.

Throughout this disclosure, various aspects thereof can be presented in a range format. It should be understood that the description in range format is merely for convenience and brevity and should not be construed as an inflexible limitation on the scope of the present disclosure. Accordingly, the description of a range should be considered to have specifically disclosed all the possible subranges as well as individual numerical values within that range. For example, description of a range, such as from 1 to 6, should be considered to have specifically disclosed subranges, such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

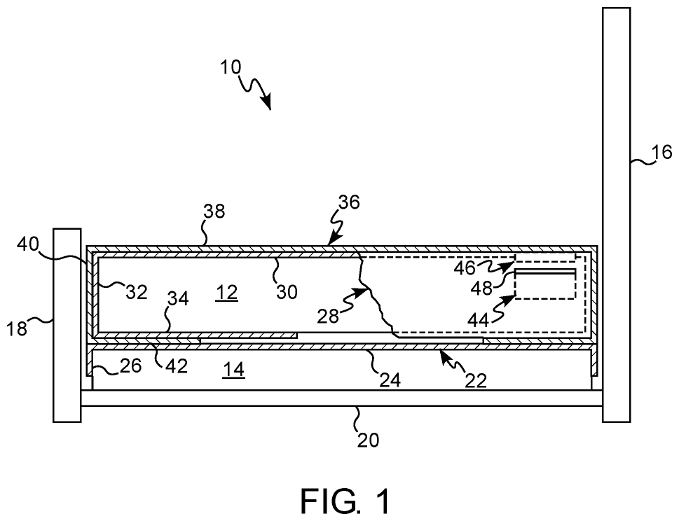

Referring to the drawings, FIG. 1 illustrates a bed system 10 including a mattress 12, a box spring 14, a headboard 16 and a footboard 18. As is known, headboard 16 and footboard 18 are joined by a frame including a plurality of frame members 20, one of which is shown in FIG. 1.

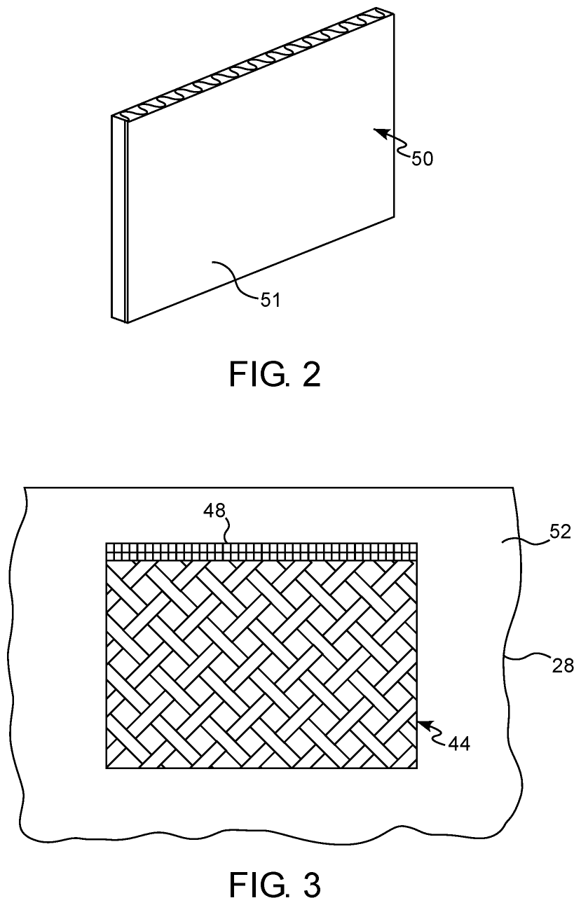

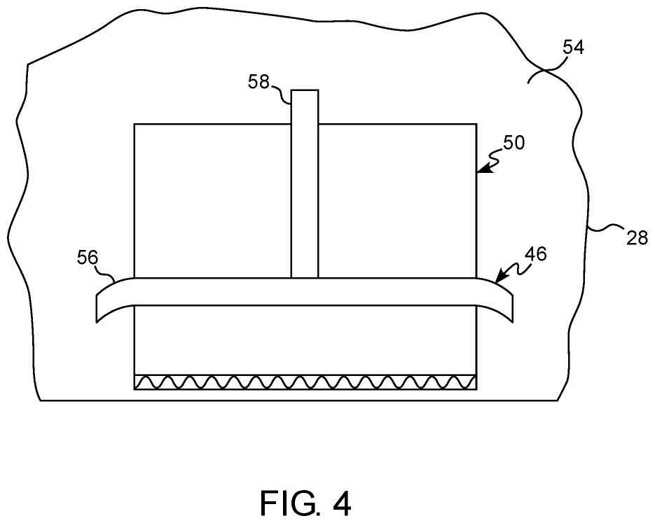

As described in greater detail below, the bed system 10 includes at least one bed bug monitoring interface 44, 46 adjacent the mattress 12 or box spring 14. A bed bug monitor 50 (FIGS. 2 and 4) is received within the bed bug monitoring interface 44 or 46.

In sum, the present disclosure provides a bed bug monitoring system comprising bedding material, described in greater detail below, including a top component for covering a top surface of the mattress or box spring, and a side component downwardly depending from the top component. The bed bug monitoring system additionally comprises a bed bug monitoring interface adjacent the top component or side component, and a bed bug monitor received within the bed bug monitoring interface.

As shown in FIG. 1, both the mattress 12 and box spring 14 are covered by bedding material. More particularly, the box spring is covered by a box spring skirt 22 having a top component 24 covering the top surface of the box spring. The top component 24 is bounded by a side component 26 connected to the top component and downwardly depending from the top component around several vertical sides of the box spring 14, preferably contiguously around all sides of the box spring.

FIG. 1 further shows that the mattress 12 is covered by bedding material including a mattress cover or protector 28 having a top component 30 covering the top surface of the mattress. The top component 30 is bounded by a side component 32 connected to the top component and downwardly depending from the top component around all vertical sides of the mattress. In certain embodiments, the side component 32, in turn, can be connected to a bottom component 34, which covers at least a portion of the bottom surface of the mattress. In FIG. 1, the mattress cover or protector 28 has an open bottom. It is understood, however, that the mattress cover or protector 28 may be a mattress encasement having a fully enclosed bottom component whereby the mattress would be fully encased within the mattress cover or protector. The mattress cover or protector 28 may also have a slippery side component such as the mattress cover or protector disclosed in U.S. Pat. Nos. 9,179,783 and 9,808,095, the disclosures of which are incorporated by reference herein in their entirety for all purposes.

FIG. 1 additionally shows that the mattress 12 is covered by bedding material including a fitted sheet 36 having a top component 38 covering the top surface of the mattress cover or protector 28. The top component 38 is bounded by a side component 40. The side component 40 is connected to the top component and downwardly depends from the top component and surrounds the side component 32 of the mattress cover or protector 28. In certain embodiments, the side component 40, in turn, can be connected to a bottom component 42 which covers at least a portion of the bottom surface of the mattress cover or protector 28. In FIG. 1, the bottom component 42 of fitted sheet 36 covers less area than the bottom component 34 of the mattress cover or protector 28.

As shown in FIG. 1, the mattress cover or protector 28 includes a plurality of monitoring interfaces 44, 46 that receive a bed bug monitor, as described in greater detail in connection with FIGS. 2-4. The bed bug monitoring interface can be positioned adjacent an inner surface of the top component of the bedding material or an inner surface of the side component of the bedding material. For example, in FIG. 1, the monitoring interface 44 supports a bed bug monitor adjacent an inner surface of the side component 32 of the mattress cover or protector 28, whereas the monitoring interface 46 supports a bed bug monitor adjacent an inner surface of the top component 30 of the mattress cover or protector 28. It is understood that there may be more than one monitoring interface provided in mattress cover or protector 28. Indeed, in certain embodiments, at least two monitoring interfaces can be provided in the mattress cover or protector 28 at opposite sides of the bed near the headboard 16. It is also understood, however, that additional monitoring interfaces may be provided near the footboard 18 if such is desired or necessary. Moreover, at least one bed bug monitoring interface may be provided on either of the mattress and box spring and disposed between the mattress and box spring.

The monitoring interfaces may be selectively closable. In this regard, the monitoring interfaces may comprise a fastener 48, such as a slot, a flap, a hook and loop fastener, a snap, a button, and/or a zipper for selectively enclosing the bed bug monitor.

FIGS. 3 and 4 illustrate that the bed bug monitoring interfaces 44, 46 include openings for permitting access of bed bugs to the bed bug monitor 50. FIG. 3 shows an embodiment of a monitoring interface 44 situated against an inner surface 52 of a side component of a bedding material, such as mattress cover or protector 28. As seen in FIG. 3, monitoring interface 44 is constructed as a mesh pocket or pouch, which removably retains a bed bug monitor and is selectively closable at its top by a fastener 48 in the form of a zipper. It is understood that by being formed of mesh, the monitoring interface 44 affords bed bugs ready access though the openings in the mesh to a bed bug monitor, such as monitor 50 of FIG. 2 contained in the monitoring interface. Alternatively, the bed bug monitoring interface as any porous or permeable material sufficient to allow bed bugs and other similar insects to readily traverse to reach the enclosed bed bug monitor 50.

FIG. 4 shows another exemplary embodiment of a monitoring interface 46 situated against an inner surface 54 of a top component of a bedding material, such as mattress cover or protector 28. As seen in FIG. 4, monitoring interface 46 is constructed as a strap harness, including, e.g., at least one elastic strap 56, the ends of which are sewn or otherwise fixedly attached to bedding material 28. The harness may also include another elastic or inelastic strap 58 to serve as a stop against over-insertion of a bed bug monitor 50 into the monitoring interface. Monitoring interface 46 retains the bed bug monitor 50 by sliding the monitor underneath the strap 56 and releases the bed bug monitor upon sliding the monitor out from under the strap. Unlike monitoring interface 44, monitoring interface 46 does not require a fastener in order to gain access to the bed bug monitor 50. That is, a user merely lifts the bedding material 28 proximate the monitoring interface 46 from the bed 12 in order to gain access to the inner surface 54 of the top component of the bedding material and, thus, to the monitoring interface 46.

It is understood that the positions of monitoring interfaces 44, 46 could be reversed, i.e., monitoring interface 44 may be situated against the inner surface 54 of the top component of bedding material such as mattress cover or protector 28 and monitoring interface 46 may be situated against the inner surface 52 of a side component of bedding material such as mattress cover or protector 28.

In addition, in accordance with other exemplary embodiments of the present disclosure, monitoring interfaces similar to monitoring interfaces 44, 46 may be provided in or on other bedding material, such as box spring skirt 22, fitted sheet 36, mattress 12, and/or box spring 14, or directly attached the mattress, box spring or component of the bed frame.

Referring to FIG. 2, there is shown a bed bug monitor 50 in accordance with an embodiment of the present disclosure. As shown in FIG. 2, bed bug monitor 50 may be in the form of a bed bug harborage, such as a fibrous material, e.g., corrugated cardboard. It is understood, however, that bed bug monitor 50 may assume other forms, including, without limitation, a glue trap or a pitfall trap such as those disclosed in U.S. Pat. No. 9,144,233 (the disclosure of which is incorporated herein in its entirety for all purposes), and textured materials that retain pesticides in a fashion that allows bed bugs to pick up the pesticides on their bodies when exposed thereto, any or all of which may also include at least one lure 51 sufficient to attract bed bugs. Such lure(s) may include, without limitation, any solid, liquid, gas or vapor state attractants such as pheromones, blood, heat, vapor, or gas (e.g., CO₂) which may be applied to the bed bug monitor by suitable solid, liquid or gaseous delivery systems described below.

When constructed of fibrous material such as corrugated cardboard, the bed bug monitor 50 may be constructed as a substantially planar and flexible to rigid member having varying dimensions to suit the needs of the bed bug monitoring system. For example, the areal dimensions of the bed bug monitor may range from ½ inch by ½ inch, 1 inch by 1 inch, 2 inches by 2 inches, 3 inches by 3 inches, 4 inches by 4 inches, 5 inches by 5 inches, 6 inches by 6 inches, 7 inches by 7 inches, 8 inches by 8 inches, 9 inches by 9 inches, 10 inches by 10 inches, 11 inches by 11 inches, 12 inches by 12 inches, or any dimensions or shapes therebetween. Suitable thicknesses of the bed bug monitor may range from ¼ inch, ½ inch, ¾ inch to 1 inch.

In addition, the at least one lure 51 may be disposed in and/or on the bed bug monitor 50, by coating, dipping, spraying, or sputtering which covers the exterior surfaces and/or interior corrugations or pores.

In all of the embodiments of the subject disclosure shown and described herein, there is provided bedding material with at least one integrated bed bug monitor that can be easily removed and inspected at will. The bed bug monitor(s) may remain in their monitoring interfaces for as few as 7 days or for as long as 30-60 days, as necessary to gather tangible evidence of bed bug infestation.

While the subject disclosure has been described with reference to certain exemplary embodiments, it will be appreciated by those skilled in the art that various changes may be made and equivalents may be substituted for elements thereof without departing from the scope of the subject disclosure. In addition, modifications may be made to adapt a particular situation or material to the teachings of the subject disclosure without departing from the essential scope thereof.

It is to be understood, therefore, that the present disclosure not be limited to the particular aspects disclosed, but it is intended to cover modifications within the scope of the claims set forth herein.

I/we claim:

1. A bed bug monitoring system comprising:
bedding material that includes:
a top component for covering a top surface of a mattress or a box spring; and
a side component downwardly depending from the top component;
a bed bug monitoring interface adjacent the top component or side component; and
a bed bug monitor received within the bed bug monitoring interface.

2. The bed bug monitoring system of claim 1, wherein the bed bug monitoring interface is adjacent an inner surface of the top component or an inner surface of the side component.

3. The bed bug monitoring system of claim 1, wherein the bed bug monitoring interface includes openings for permitting access of bed bugs to the bed bug monitor.

4. The bed bug monitoring system of claim 1, wherein the bed bug monitoring interface is a mesh pouch, a strap harness, or an elastic strap.

5. The bed bug monitoring system of claim 1, wherein the bed bug monitoring interface is selectively closable.

6. The bed bug monitoring system of claim 1, wherein the bed bug monitoring interface includes a fastener for selectively enclosing the bed bug monitor.

7. The bed bug monitoring system of claim 6, wherein the fastener is selected from a zipper, a slot, a flap, a hook and loop-type fastener, a snap, or a button.

8. The bed bug monitoring system of claim 1, wherein the bed bug monitor is a glue trap, a pitfall trap, fibrous materials, or textured materials that retain pesticides.

9. The bed bug monitoring system of claim 8, wherein the bed bug monitor further includes at least one lure sufficient to attract bed bugs.

10. The bed bug monitoring system of claim 9, wherein the lure is pheromones, blood, heat, vapor, or gas.

11. A bed system comprising:
at least one of a mattress and a box spring;
a bed bug monitoring interface adjacent the mattress or box spring; and
a bed bug monitor received within the bed bug monitoring interface.

12. The bed system of claim 11, wherein the bed bug monitor is a glue trap, a pitfall trap, fibrous materials, or textured materials that retain pesticides.

13. The bed system of claim 12, wherein the bed bug monitor further includes at least one lure sufficient to attract bed bugs

14. The bed system of claim 13, wherein the lure is pheromones, blood, heat, vapor, or gas.

15. The bed system of claim 11, wherein the bed bug monitoring interface is disposed between the mattress and box spring.
